(19) United States
(12) Patent Application Publication
(10) Pub. No.: US 2015/0136897 A1
(43) Pub. Date: May 21, 2015

(54) AIRCRAFT, PREFERABLY UNMANNED

(71) Applicants: Florian Seibel, Neubiberg (DE); Michael Wohlfahrt, Stegen (DE); Michael Kriegel, Hohenkirchen (DE)

(72) Inventors: Florian Seibel, Neubiberg (DE); Michael Wohlfahrt, Stegen (DE); Michael Kriegel, Hohenkirchen (DE)

(73) Assignee: LOGO-TEAM UG (HAFTUNGSBESCHRANKT), Stegen (DE)

(21) Appl. No.: 14/404,195

(22) PCT Filed: May 31, 2013
(86) PCT No.: PCT/EP2013/061241

§ 371 Date: Nov. 26, 2014

(30) Foreign Application Priority Data
Jun. 1, 2012 (DE) 10 2012 104 783.9

(51) Int. Cl. B64C 39/02

(52) U.S. Cl. CPC B64C 39/024; B64C 2201/021; B64C 2201/024; B64C 2201/042; B64C 2201/104; B64C 2201/108; B64C 2201/06
USPC 244/6

(57) ABSTRACT

The invention relates to an aircraft (1), preferably an unmanned aircraft (UAV), drone, or Unmanned Aerial System (UAS), comprising a rigid wing (2) which enables aerodynamic horizontal flight, and at least four rotors (4, 4′) which are driven by means of controllable electric motors (5) and which can be pivoted between a vertical starting position and a horizontal flight position by means of a pivoting mechanism (7), wherein all electric motors (5) and rotors (4) are arranged on the wing (2).

### TECHNICAL FIELD

The present invention relates to an aerial vehicle, preferably a UAV (Unmanned Aerial Vehicle), a drone and/or a UAS (Unmanned Aerial System).

### STATE OF THE ART

In the field of Unmanned Aerial Vehicles (UAVs), drones and/or Unmanned Aerial Systems, different concepts concerning the take-off and landing of such aerial vehicles exist. An example is a drone, designed as conventional fixed-wing aerial vehicle, which is started by means of a catapult. The achievable flight time of these aerial vehicles is inherently quite high, as these aerial vehicles have a high aerodynamic quality. However, the preparations for take-off are highly cumbersome due to the required infrastructure in the form of a catapult or a runway. Landing also needs preparations, since these aerial vehicles either require a runway, or are landed in a net or by a parachute.

Another known example is a drone that operates as rotary wing aircraft. Compared to fixed-wing aerial vehicles, the achievable possible flight time is relatively short due to the systemic high use of energy. However, the preparations for take-off and landing are faster so that these aerial vehicles are rapidly operational. They neither require the construction of a catapult or runway, nor the placement of safety nets.

UAVs and particularly so-called MAV (Micro Aerial vehicles), which can be used for surveillance and exploration purposes, are of great benefit for civil as well as military operation.

Such UAVs can for example be employed in civil operations for the monitoring and control of gas and oil pipelines, for an early detection of leaks and to assess the need for maintenance of the pipeline. Additional civil operational scenarios include for example the security of harbor facilities or in the large-scale industry, monitoring and maintenance of offshore facilities such as wind farms, drilling and production platforms, monitoring of transmission lines, tasks in the area of environmental protection and nature conservation, monitoring of forests and the forest condition, exploring the extent of damage after natural disasters, surveillance and reconnaissance in the field of species conservation for the determination of animal populations, monitoring the compliance with fishing quotas, protection of historical buildings and monuments as well as inspection of building structures, monitoring of major events such as regattas, rallies and other sporting events, use in the field of aerial photography and filming and for cartography.

In the scientific field such UAVs can be used for the exploration of oil deposits and other geological formations, for studying volcanoes and the corresponding prediction of volcanic eruptions, or for mapping archaeological sites. In agriculture, such UAVs can be used to monitor agricultural areas, which can be of great importance in the field of so-called “precision farming”, in order to plan and monitor the appropriate use of machinery. Moreover, the growth of the respective crop grown on a monitored area can be measured, for example by means of infrared cameras. It is also possible to check the overall condition of the crop and thus determine the optimum time for harvesting. Furthermore, a possible pest infestation can be detected in time, so that appropriate countermeasures can be taken. Additionally, by aerial determination of different soil conditions within an area of the field, the fertilizer input can be planned and optimized for specific sections.

Other operational scenarios involve the use by authorities and organizations with security tasks (BOS), such as SAR (Search and Rescue), civil protection and emergency response, the determination of the extent of damage after natural disasters (e.g. storms, floods, avalanches, mudslides, large and wild fires, earthquakes, tsunamis, volcanic activity), the determination of the extent of damage after disasters of a technical-biological nature (e.g. nuclear reactor accidents, chemical or oil spills), supporting operation coordination through live images, monitoring major events and demonstrations, traffic monitoring, as well as the use as a communications relay to extend the range.

In the military field UAVs are used for reconnaissance, to monitor objects such as base camps, to secure borders, to secure convoys and can further be used for civil protection, emergency response and SAR missions. Additional deployments in the military environment include CSAR (Combat Search and Rescue), the use as communication relays (e.g. to request CSAR forces, to increase the range), the coordination of replenishment of supplies, as escorts (e.g. as convoy protection), for patrol flights and military surveillance flights, for tactical reconnaissance (e.g. in urban terrain or even inside buildings, BDA), for monitoring, target marking, explosive ordnance searches (e.g. mines or IED detection, tracking of NBC contamination), for electronic warfare, as well as for the deployment of ordnance (e.g. light guided missiles).

An example of such a rotary-wing aircraft is described in WO 2009/115300 A1, whereby the said aircraft is adapted to carry a forward-looking surveillance camera.

Another approach is the combination of the rotary-wing concept and the fixed-wing concept, so that on the one hand, a vertical take-off and vertical landing (VTOL—Vertical Take-Off and Landing) is possible, and on the other hand a horizontal flight can be carried out due to the aerodynamically designed fixed-wing.

This concept has long been used in the field of manned aerial vehicles, the Bell-Boeing V-22 (“Osprey”) being a particularly prominent example.

In the field of UAVs, an example is known from U.S. 2011/0001020 A1, which is based on a so-called Quad-Tilt Rotor Aircraft (QTR), disclosing a corresponding combination of a rotary-wing aircraft and fixed-wing aircraft. Accordingly, the four rotors are arranged so that two main rotors are positioned at the outer ends of the main wing, and two significantly smaller rotors are positioned at the outer ends of the elevator.

An article by Gerardo Ramon Flores et al.: “Quad-Tilting Rotor Convertible MAV: Modelling and real-time Hoover Flight Control”, Journal of Intelligent & Robotic Systems (2012) 65: 457-471 further discloses an UAV comprising a fuselage with a main wing, elevator and rudder as well as four rotors, which are arranged directly on the fuselage of the aerial vehicle. Two rotors are positioned in front of and two behind the main wing, resulting in an H-configuration of the rotors.

### REPRESENTATION OF THE INVENTION

Based on the cited prior art, it is an objective of the present invention to specify an aerial vehicle with VTOL capabilities, preferably an UAV, which provides further improved properties with respect to different applications.

An aerial vehicle comprising the features of claim 1 meets this objective. The dependent claims describe further advantageous formations.

Accordingly, an aerial vehicle, preferably an Unmanned Aerial Vehicle (UAV), is proposed, comprising a fixed-wing, which allows an aerodynamic horizontal flight. Furthermore, at least four rotors, which are driven by controllable electric motors, are provided. The rotors can, by means of a pivoting mechanism, change between a vertical take-off position and a horizontal flight position. According to the invention, all electric motors and rotors are adjusted on the fixed-wing.

Given that all rotors are arranged on the fixed-wing and are pivotable, the aerial vehicle possesses improved VTOL capabilities. Accordingly, the described aerial vehicle is capable of both vertical take-off and vertical landing as well as proceeding to horizontal flight through a transition maneuver. This greatly improves the field of application given that there is no need for a runway, parachute or safety net. Due to the wing's more effective generation of lift in level flight there is also a vast increase in the flight time and flight range.

The centre of mass of the aircraft at take-off, during landing and during hover-like conditions coincides with the centre of lift of the thrust of the four rotors. Subject to design adjustments for stability, the centre of gravity of the aerial vehicle also coincides with the centre of gravity of the lift in dynamic horizontal flight. In other words, the centre of gravity of the aerial vehicle for dynamic flight can be aligned in the same way as for hovering. Because of this, the design of the rotors and the electric motor is facilitated and equally sized rotors and electric motors can be used, providing substantially identical thrust. Control is also simplified due to the identical design of the four rotors. This simplification of control is particularly evident when compared to concepts using differently sized rotors.

Moreover, the arrangement of the electric motors and the rotors on the wing results in significant structural advantages in the design of the aerial vehicle. As a result of the arrangement of the masses of the electric motor and the rotors on the wing, the root bending momentum at the wing fuselage junction can be reduced in dynamic operation. Accordingly, the spar of the wing can be dimensioned with a lower strength as regards the same aircraft design for a given load factor. This results in a reduction of the mass of the spar, so that either the payload of the aerial vehicle can be raised, or the efficiency is enhanced with respect to the use of drive energy. These advantages cannot be achieved when conventionally attaching the motors and rotors directly to the fuselage.

Furthermore, by arranging the four rotors on the fixed-wing it is possible to improve the maneuverability or, as the case may be, the maneuvering characteristics while hovering, so that the hover of the aerial vehicle in principle corresponds to the hover of a conventional floating platform. Therefore the aerial vehicle can on the one hand be used in dynamic operation for remote monitoring and on the other hand, in identical configuration, also as a stationary surveillance platform. This is particularly advantageous for monitoring tasks, since e.g. a pipeline can first be followed over its length in a dynamic operation while in critical areas a particularly accurate control or monitoring can be achieved by operating as a floating platform.

Furthermore, it follows from the specific design that while all four rotors are needed for hovering, only a fraction of the hover performance is necessary for the aerodynamic horizontal flight and therefore it is possible to switch off two of the four rotors. This signifies a very efficient use of the existing drive energy, since the two front rotors can be aerodynamically optimized for the horizontal flight while the two rear rotors can be optimized for hovering. In horizontal flight, the two rear rotors, for example, can then be switched off and folded backwards in an aerodynamically favorable way.

As a result, the submitted aerial vehicle is a combination of a floating platform and an aerodynamic aircraft, enabling vertical take-off and vertical landing on all terrains. For this reason, these aerial vehicles are rapidly operable. In particular, no cumbersome construction of take-off or landing equipment, for example in the form of a catapult or safety net, is necessary.

The proposed aerial vehicle further features a very wide speed range between a hovering speed of 0 km/h to high dynamic flight speeds in the range of e.g. 300 km/h, whereby the wide range and long flight times achieved by the dynamic flight features can be combined with the easy take-off and landing features.

A further advantage of the described aerial vehicle is that the rigid wing can be aerodynamically optimized so that it only has to provide the full lift, carrying the aerial vehicle, at relatively high speed. Accordingly it can have a very efficient wing profile, optimized for cruise flight. Since the VTOL features enable take-off or landing without the aid of the fixed-wing, the wing profile can be optimized for a more efficient cruise flight operation. This results in a very sleek and highly efficient wing profile, which allows for an even more efficient handling of the drive energy. In other words, a highly efficient aerodynamic design is achieved for the dynamic flight without having to accommodate compromises required for conventional take-offs or conventional landings, such as the provision of take-off and landing flaps or of high-lift systems.

Furthermore, since the wings can be aerodynamically optimized to a single operating point, it is possible to achieve an unusually high glide ratio (in relation to the size of the aerial vehicle), so that a completely silent and vibration-free operation of the aerial vehicle, when gliding over a long distance, can be achieved. The aerial vehicle can, in its aerodynamic forward flight, also preferably be operated in a “sawtooth trajectory” with short thrust phases and a corresponding gain in height combined with a longer gliding phase depending on the drive characteristics. Thus in addition to an advantageous increase of flight range, also the above-mentioned vibration-free flight when gliding can be realized.

Preferably, the aerial vehicle includes an automatic flight control device, which stabilizes it during vertical take-off and vertical landing, hovering and in the transition to and from hover to the dynamic flight mode. For this, the principally counter-rotating rotors are controlled according to their thrust or with respect to the torque actuated by the electric motors so that a stable flight during take-off and landing, hovering and in the transition phase is provided. Due to the possibility to separately control the thrust of all four motors and to pivot all four rotors independently, a safe transition into the dynamic flight mode is enabled.

The control device is preferably configured in such a way as to enable a simple maneuver of the aerial vehicle while hovering. In particular, a simple rotation around the vertical axis and forward, backward and sideways movement of the aerial vehicle can be effected through an appropriate control of the rotors. Rotation of the aircraft can be achieved for example by changing the allocation of thrust between the four rotors. Given that the rotors typically rotate in opposite directions, the change in distribution of the thrust while maintaining the same total thrust results in a rotational torque corresponding to the higher thrust by the rotor whose corresponding torque is no longer absorbed by the remaining rotors. This mechanism of controlling a floating platforms or hovering aerial vehicles is generally known.

In a further preferred embodiment, all the rotors of the aerial vehicle are pivoted in one direction to attain the vertical take-off position. For instance, all rotors can be pivoted upwards for take-off and landing. Thus, the provision of an undercarriage or landing gear can be dispensed with and correspondingly the aerodynamics in level flight is not thereby disrupted. This also results in weight gains. Before take-off and after landing, the aerial vehicle simply lies on its fuselage and engine nacelles.

The rotors, together with their electric motors, are preferably arranged in the middle section as regards the length of the fixed-wing, preferably in the first third of the wingspan. The arrangement in the inner third is done for reasons of better control as well as structural design. The masses of the aerial vehicle are thus arranged more centrally and compact. This results in reduced moments of inertia and therefore better dynamic responses as well as easier maneuverability in hover. However, in principle it would also be possible to position the motors and rotors further towards the tip of the wing.

The electric motors and the rotors are preferably placed on the fixed-wing via appropriate engine nacelles so that a collision of the rotors in horizontal flight or hover is prevented and so that the proportion of vertical thrust generated by the fixed-wing is not excessively covered. At the same time, an efficient flow against the fixed-wing is generated in forward flight.

Furthermore, the placement of the engine nacelles and the resulting distance between the rotors enables the characteristic leverage of a floating platform. It is predominantly the arrangement of the rotors in X-formation that ensures a particularly stable flight performance of the aerial vehicle, both when hovering and in horizontal flight.

The fixed-wing is preferentially equipped with a profile which allows for aerodynamic flight at a minimum steady flight speed/stall speed of at least 50 km/h, preferably however 100 km/h. Further, the rotors are designed and the electric motors dimensioned so that they also provide vertical thrust during the transition phase and up to a predetermined speed at which the fixed-wing can generate sufficient lift. This way it is possible to optimize the aerodynamic fixed-wing for the flight phase without having to consider take-off and landing when designing the wing.

By comparison, the conventional use of a fixed-wing aerial vehicle that generates dynamic lift comprises generally at least two main applications: Firstly the cruise flight and secondly also flying at slow speed, encompassing take-off and landing. To account for both main applications, compromises must be made in the design of the wing profile. Accordingly, the conventional wing profiles are designed such that they enable both a safe slow flight during take-off and landing and a safe cruise flight. Conversely, conventional wing profiles, which are designed in such a manner, cannot be optimized exclusively for cruise flight since an aerial vehicle equipped with such a wing would neither be able to take-off nor land.

As regards the proposed aerial vehicle, which has VTOL features and which transitions autonomously, both from hover to dynamic flight and from dynamic flight to hover, slow flight properties are of secondary importance. This allows for the optimization of the cruise features of the wing profile in order to achieve an efficient handling of limited energy and to optimize the aerial vehicle's range and flight time.

The wing is preferably optimized exclusively for cruise flight. This could imply that the aerodynamically optimized wing does not allow for slow forward flight.

The energy demand, which depends on the weight and the reciprocal glide ratio, determines the flight time and range during cruise flight. This means that the L/D polar curve of the proposed aerial vehicle can be designed specifically to add the smallest profile drag for the corresponding c_{L} value. In the context of the proposed aerial vehicle, other c_{L} values hardly require attention. As a result, the profile drag is significantly smaller than in profile designs that also cover other areas (e.g. take-off and landing).

Furthermore, dispensing with slow flight arrangements (with possible subsequent problems with the Reynolds number) allows the optimization of the wing aspect ratio in many areas. A substantial increase of the aspect ratio becomes possible, leading to a reduction in the induced drag and thus to a further improvement of the reciprocal glide ratio.

The submitted aerial vehicle therefore enables exceptional aerodynamic quality by combining aerodynamic cruise flight with take-off and landing in hover. That is all the more so because, when gliding without engine power, the propellers can be folded aerodynamically to the engine nacelles.

In addition to battery cells, a fuel cell or solar cell is preferentially foreseen as the aerial vehicle's energy source. The flight time can thus be optimized, particularly in dynamic flight.

Preferably, a control device is provided, which monitors the state of charge of the onboard batteries and simultaneously monitors the flight distance to ensure a safe return to the take-off point. If the state of charge of the batteries reaches a level that would just allow the return to and vertical landing at the starting point—depending on the operating mode—the operator is either informed of the situation or the aerial vehicle is returned directly to the starting point and landed automatically.

In order to further improve the flight characteristics in dynamic flight, at least one pair of rotors is designed as folding propellers or folding rotors. During dynamic flight this pair of rotors can be switched off and subsequently folded, improving the aerial vehicle's aerodynamic characteristics. In another preferred embodiment, all rotors are designed as folding rotors that can be folded during glide or whilst gliding and after reaching a specified altitude. Correspondingly, the aerodynamic characteristics of the glide are further improved. This way, gliding over very long distances is possible. As a result of the above-mentioned optimization of the wing profile, very small gliding angles can be achieved.

Vibrations induced by the motors or rotors are no longer transmitted on the aerial vehicle during glide. Therefore, it is possible to monitor from higher altitudes by means of sensitive optical devices without having to equip them with vibration compensation or decoupling. As a result, sensitive optical devices can be installed and attached to the aerial vehicle at relatively low cost since vibration compensation can be dispensed with when the aerial vehicle is gliding. Thus the proposed aerial vehicle is particularly suitable for monitoring with sensitive optical devices.

In a further preferred embodiment of the aerial vehicle the controller is designed so that after reaching a predetermined altitude in dynamic flight, the engines switch off and thus automatically initiating glide. The controller is also preferably designed so that when reaching a predetermined minimum altitude during glide, the motors re-start automatically and the aerial vehicle is brought to a stable level or climb flight.

The controller is further preferably configured to automatically direct the aerial vehicle to the take-off position when receiving a corresponding control command. Upon arrival, the transition is then carried out and the aerial vehicle landed vertically.

In a particularly preferred embodiment, the aerial vehicle is of a modular design. In this embodiment, the aerial vehicle entails different variants of equipment and thus can also be employed in different variants. The aerial vehicle can consequently either solely be used as a floating platform, in which case the necessary components for dynamic forward flight can be replaced, omitted or dismantled. Correspondingly, the starting weight of the aerial vehicle when merely used as a floating platform can be reduced, thus either accomplishing a longer flight time in hover or the transportation of a higher payload. This can be achieved by removing the tailsection with the tailplanes as well as by dismantling the outer parts of the rigid wing thus resulting in a highly compact floating platform. The floating platform can subsequently be converted back into the previously described aerial vehicle, which is optimized for dynamic level flight. This can be achieved by re-attaching the outer wings, for example the outer two-thirds of the wingspan, and by re-assembling the tail section with the rudder and elevator.

In another variant, the previously mentioned components can be combined so as to comprise a conventional fixed-wing aerial vehicle. Correspondingly, a conventional fuselage nose with a single propeller is connected to the floating platform module and the four engines are removed along with the left and right engine nacelles. The left and right outer wings are thus plugged directly onto the wing centre section.

Furthermore, due to the modular structure and by attaching different outer wing modules to the floating platform, the flight quality of the aerial vehicle during dynamic flight can be adapted to the task in hand. In particular, different wing modules with differing wing profiles can be attached, which are optimized for example for different speed ranges or different flight altitudes. Accordingly, slow speed flight characteristics can also be provided for by appropriately designed wing profiles, so that slow flight monitoring becomes possible.

Preferably, the aerial vehicle module then includes two different sets of outer wings. A first set is optimized exclusively for cruise and a second set also has sufficient slow speed flight characteristics, enabling conventional take-off and landing in slow flight.

Due to the modular design, the aerial vehicle has a small pack size, so that it can be easily transported to its respective sites. Furthermore, it is easy to replace any modules that may have been damaged.

The use of electric propulsion is advantageous for rapidly and accurately controlling the rotor rotational speed External disturbances can thus effectively be controlled. In conformity with the concept of fast control of the thrust or torque by changing the rotor rotational speed, no adjustable propellers are necessary. Fixed pitch propellers which for aerodynamic reasons are preferably foldable, allow a particularly simple and easy assembly of the aerial vehicle.

Compared to conventional piston engines or turbines, the electric propulsion is moreover decidedly quiet and emission-free, at least at the place of operation. At the same time, brushless electric motors are highly reliable, not very complex and are almost maintenance-free. Furthermore, brushless electric motors are highly efficient and light. At small dimensions over a wide speed range, they generate high performance and high torque. This way, the total mass of the aerial vehicle as well as moments of inertia about the centre of mass can be kept small. Also, the highly reliable electric motors can be arranged inside an engine nacelle with aerodynamically advantageous dimensions.

### BRIEF DESCRIPTION OF THE FIGURES

Additional preferred embodiments and aspects of the present invention will be further illustrated by the following description of the figures. In the drawings, which form a part of this specification:

FIG. 1 is a schematic plan view of a hovering aerial vehicle pursuant to one embodiment of the present invention;

FIG. 2 is a schematic side view of the aerial vehicle of FIG. 1 in hover;

FIG. 3 is a schematic front view of the aerial vehicle of FIGS. 1 and 2 in hover;

FIG. 4 is a schematic plan view of the aerial vehicle of the preceding figures in aerodynamic horizontal flight;

FIG. 5 is a schematic side view of the aerial vehicle of FIG. 4 in horizontal flight;

FIG. 6 is a schematic front view of the aerial vehicle of FIGS. 4 and 5 in horizontal flight;

FIG. 7 is a schematic plan view of the aerial vehicle of the previous figures during the transition from hover to aerodynamic forward flight;

FIG. 8 is a schematic side view of the aerial vehicle of FIG. 7 during the transition from hover to aerodynamic forward flight;

FIG. 9 is a schematic front view of the aerial vehicle of FIGS. 7 and 8 during the transition from hover to aerodynamic forward flight;

FIG. 10 is a schematic plan view of the aerial vehicle of the previous figures during the transition from aerodynamic forward flight to hover;

FIG. 11 is a schematic side view of the aerial vehicle of FIG. 10 during the transition from aerodynamic forward flight to hover;

FIG. 12 is a schematic front view of the aerial vehicle of FIGS. 10 and 11 during the transition from aerodynamic forward flight to hover;

FIG. 13 is a schematic illustration of an aerial vehicle with a modular structure, which shows a floating platform, an aerial vehicle according to an embodiment of the invention and a fixed-wing aerial vehicle;

FIG. 14 are schematic diagrams of the thrust from the motor, the lift capacity of the wing, the speed of the aerial vehicle and the propulsion of the aerial vehicle during the transition from hover to dynamic forward flight; and

FIG. 15 are schematic diagrams of the thrust from the motor, the lift capacity of the wing, the speed of the aerial vehicle and the propulsion of the aerial vehicle during the transition from dynamic forward flight to hover.

### DETAILED DESCRIPTION OF PREFERRED EMBODIMENTS

The following section describes preferred embodiments with reference to the figures. Identical, similar or equivalent elements are designated with identical reference signs. In order to avoid redundancies, repetition of the descriptions of those elements is partially omitted.

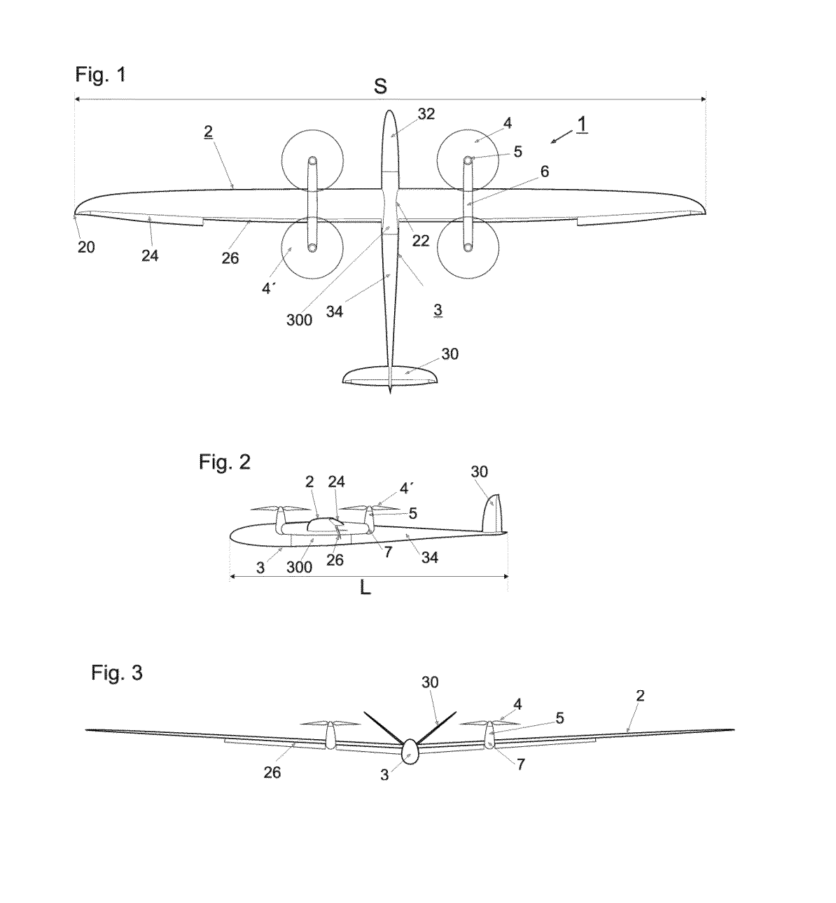

FIGS. 1 to 3 show schematic plan, side and front views of an aerial vehicle according to an embodiment of the present invention. The aerial vehicle 1 encompasses a rigid aerodynamic wing 2, which is formed in a generally known way. The illustrated fixed wing 2 is optimized for aerodynamic flight. Above a certain speed, for example 50 km/h, it generates so much lift that the entire aerial vehicle 1 can be dynamically operated in forward flight.

The wing 2 has an outer wingtip 20 and a connecting area 22 to the fuselage 3 of the aerial vehicle 1. Furthermore, ailerons 24 are provided, which are used to control the aerial vehicle in the aerodynamic forward flight around the roll axis. Flaps 26 are also provided, which act as an air brake.

The wing 2 has a span S, which is designed depending on the area of application and the desired lift or flight weight. As an example, which corresponds to the schematic embodiment in FIG. 1, the aerial vehicle 1 has a span S of about 3.4 m.

The fuselage 3 has a rear section 34 with a tail section 30, which, in the illustrated embodiment, is formed as a V-tail. It is also possible to design the tail section 30 as a T-tail, with a separate elevator and rudder. The nose 32 of the aerial vehicle 1 can for example comprise a camera or other optical and electronic monitoring devices. These monitoring devices may also be arranged in other areas of the fuselage 3, for example between the wings 2.

The wing 2 of the Aerial vehicle 1 is equipped with four rotors 4, 4′, which are each powered by a separate electric motor 5. The rotors are arranged in pairs: two—in flight direction—front rotors 4 and two rear rotors 4′. The electric motors 5 and the rotors 4, 4′ are fitted to the wing 2 by corresponding engine nacelles 6. The engine nacelle 6 extends parallel to the fuselage 3 and has at its front and rear-ends a pivot mechanism 7, to which the mounts for the engines 5 with the connected rotors 4, 4′ are attached. In other words, at each engine nacelle 6, two motors 5 and correspondingly two rotors 4, 4′ are arranged.

The engine nacelle 6 is arranged in the inner third of the wing 2 with respect to its lateral extension, and accordingly with respect to the span S of the aerial vehicle 1. Due to the relatively inner positioning of the nacelle 6 at the wing 2, the moment of inertia of the aerial vehicle 1 can be reduced.

The arrangement of the engine nacelles 6 on the wing 2 moreover results in substantial structural advantages in the design of the aerial vehicle 1. By arranging the masses—which are applied on the aerial vehicle 1 by the electric motors 5, the rotors 4, 4′ and the engine nacelles 6—on the wing 2, the root bending moment can be reduced at the wingroot during dynamic operation. With the same design of the aerial vehicle 1, the main spar of the wing 2 can thus be dimensioned with a lower strength for a given load factor. This results in a reduction of the mass of the main spar, so that either the payload of the aerial vehicle 1 can be raised, or the efficiency is enhanced with respect to the use of propulsion energy.

The rotors 4 together with the electric motors 5 can swivel upwards by means of a pivot mechanism 7, as illustrated particularly well in FIG. 2. The pivot mechanism 7 can for example be operated steplessly by means of servomotors. By the use of electric motors 5 with small structural dimensions, the entire propulsion unit comprising electric motor 5 and rotor 4, 4′ can conjointly be swiveled, so that the susceptible gearbox can be dispensed with.

In FIGS. 1 to 3 the aerial vehicle 1 is illustrated in a state in which it can hover. Thus all the rotors 4 are pivoted upwards to a vertical take-off position. The aerial vehicle 1 can consequently take-off and land vertically as well as hover.

Hover as well as take-off and landing is automatically controlled relative to the location of the aerial vehicle 1, by means of a corresponding controller, which is not illustrated here. Upon emergence of external interference, for example wind, the aerial vehicle will immediately be stabilized by directly compensating the interference with the thrust of the individual rotors through regulation by the corresponding electric motors. Since electric motors 5 are used, very short regulation rates/control pulses are possible, for example in the range of milliseconds. By operating 3-axis accelerometers, 3-axis gyroscopes/gyro sensors/torque sensor, 3-axis magnetic field sensors, a barometric altimeter and GPS, an automatic control can regulate a stabilized hover by fusing all sensor data.

The thrust of the rotors 4 during take-off and landing is adjusted so that a slow climb or slow sink of the aerial vehicle 1, while maintaining a stable flight, is possible.

When hovering, the aerial vehicle 1 can be maneuvered by rotating it in the air around its vertical axis (Yaw axis), for example by operating two paired rotors with an increased thrust so that the total of the other two rotors is reduced by this thrust. Thereby the other two rotors no longer compensate the torque, which is generated by the rotors operating with increased thrust, so that a corresponding total torque affects the aerial vehicle 1.

The hovering aerial vehicle 1 can be moved forwards and backwards by raising or lowering the thrust of the paired front rotors 4 or rear rotors 4′ and the complementary raising or lowering of the thrust of the corresponding other rotor pair of rear rotors 4′ or front rotors 4. This way, there will be a slight inclination of the aerial vehicle 1 along the lateral/pitch axis. Due to the horizontal component of the thrust caused by the inclination, the aerial vehicle 1 thus moves in the direction in which the pair of rotors 4, 4′ with reduced thrust is arranged.

The rotors 4, 4′ are preferably operated rotating in opposite directions, so that the torques of the pair of front rotors 4 and the pair of rear rotors 4′ is cancelled out and the total torque applied by the rotors to the aerial vehicle 1 in hover is equal to zero, enabling a stable hovering position. In order to implement the control scheme described above, the rotors are always operated diagonally counter-rotating.

Further, by arranging the four rotors in a X-shape—as is easily discernable in FIG. 1—the thrusts are well balanced with respect to the centre of mass of the aerial vehicle 1. The centre of mass is located in the mechanically expedient area—at the centre of lift of the wing 2—so that the centre of lift in dynamic flight coincides with the centre of gravity when hovering to within a few millimeters. That way, the rotors 4, 4′ can be dimensioned identically with regard to the electric motors 5.

The engine nacelle 6 exhibits a longitudinal expansion, which serves on the one hand to prevent a collision of the two front and rear rotors 4, 4′, which are arranged on the nacelle 6. On the other hand, the longitudinal expansion of the engine nacelle 6 also serves to provide a stable floating platform by means of the corresponding leverage, which in principle corresponds to the surface between the shafts of the electric motors 5, which enables stable operation with varying payloads.

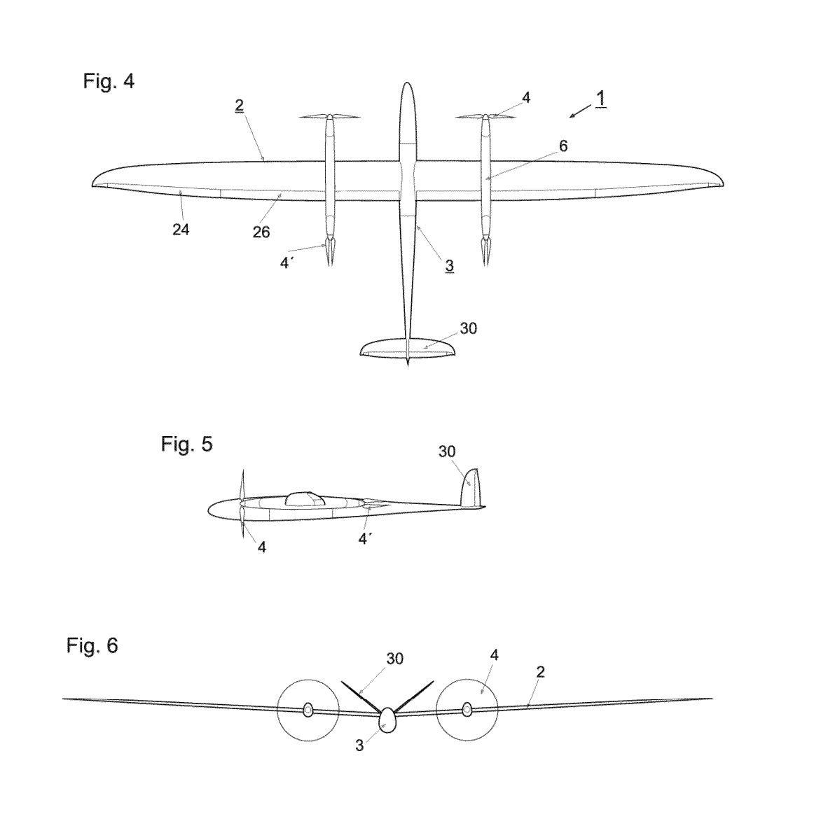

FIGS. 4 to 6 shows the in previous figures depicted aerial vehicle 1 arranged for aerodynamic forward flight. Accordingly, the front rotors 4 are folded forwards via the pivot mechanism 7 and the rear rotors 4′ are folded backwards via the pivot mechanism 7. The thus directed thrust propels the aerial vehicle 1 forward.

The flaps 26, which while in hover—as depicted in FIGS. 1 to 3—are extended to the brake/landing position to enable the largely unhindered downward downwash/flow of the rotor thrust, are now retracted in order to optimize the profile of the wing 2 for forward flight.

The aerial vehicle 1 shown in FIGS. 4 to 6 is in principle a conventional fixed-wing aircraft comprising two propulsion motors, namely the two front rotors 4 with their respective electric motors 5.

The two rear rotors 4′ are folded, because the power required for level flight is significantly lower than for hover. The power required for forward flight is only about 5% of the power necessary for hover.

By folding the rear rotors 4′, the aerodynamic characteristics in forward flight are improved. Preferably, the front rotors 4 can also be designed as folding rotors, so they can be folded during gliding phases.

This way, a hovering position as shown in FIGS. 1 to 3, resulting in a stable floating platform, as well as a highly efficient dynamic flight as depicted in FIGS. 4 to 6 can be achieved.

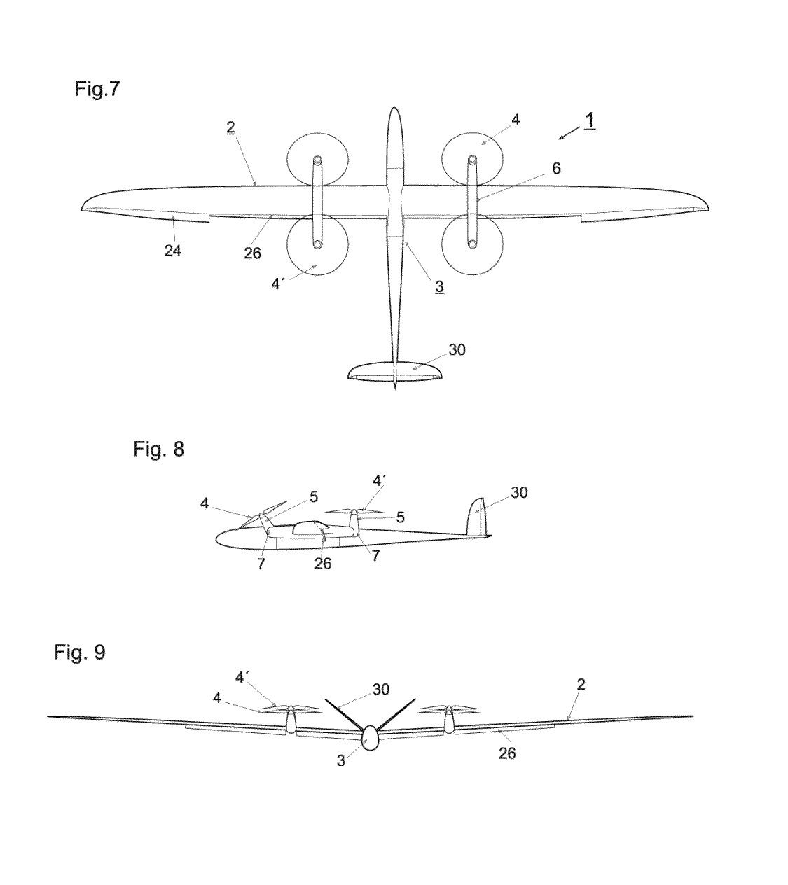

FIGS. 7 to 9 show a specific position of the rotors 4, 4′ of the aerial vehicle 1 during the transition from hover to forward flight. In order to apply forward thrust to the aerial vehicle 1, the front rotors 4 along with their electric motors 5 are gradually swiveled forward by means of the pivot mechanism 7. Thereby the aerial vehicle 1 shifts from a hovering state into a forward movement. At a certain speed, the dynamic lift on the rigid wing 2 takes over the entire lift until the dynamic horizontal flight—as illustrated in FIGS. 4 to 6—is reached due to the aerodynamic lift of the fixed wing 2. The rear rotors 4′ can then be switched off and swiveled back into an aerodynamically favorable position by means of the pivot mechanism 7.

The flaps 26 are extended to the brake position both during hover—as illustrated in FIGS. 1 to 3—and during parts of the transition, in order to, among other things, expose the rear rotors 4′ to as little vorticity/disturbing area as possible. Accordingly, the vertical thrust generated by the front rotors 4 and rear rotors 4′ is essentially the same and is not affected by the fixed wing 2.

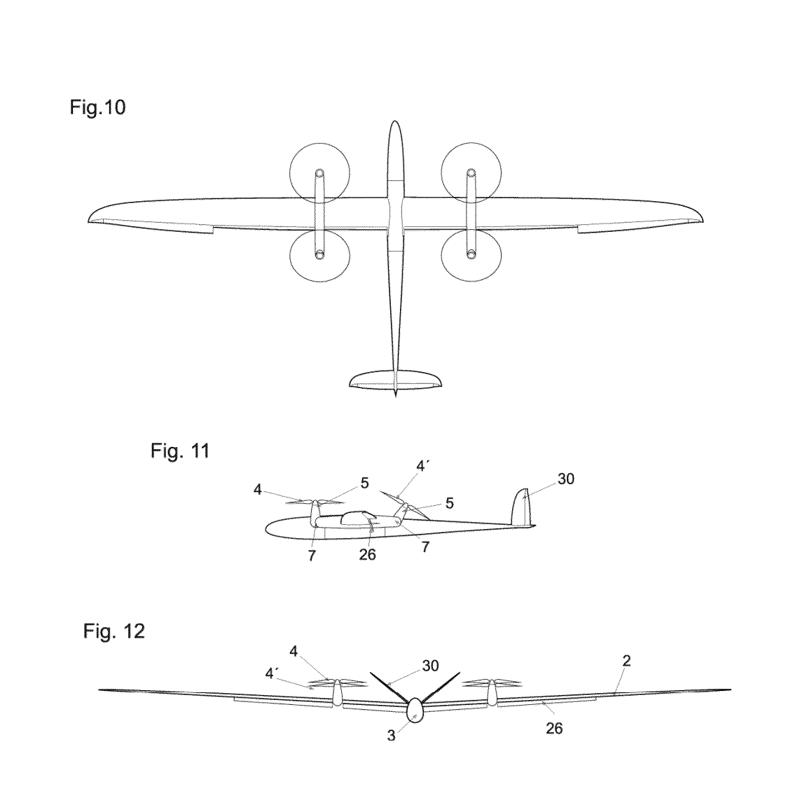

FIGS. 10 to 12 show a specific position of the rotors 4, 4′ of the aerial vehicle 1 during the transition from forward flight to hover. In order to generate lift, the front rotors 4 along with their electric motors 5 are pivoted upwards by means of the pivot mechanism 7. The rear rotors 4′ are initially pivoted back in an angle, so that they can generate lift as well as a braking thrust. Thereby the aerial vehicle 1 is decelerated, allowing the rotors 4, 4′ to gradually take over the lift, until the aerial vehicle 1 is fully in hover position as illustrated in FIGS. 1 to 3.

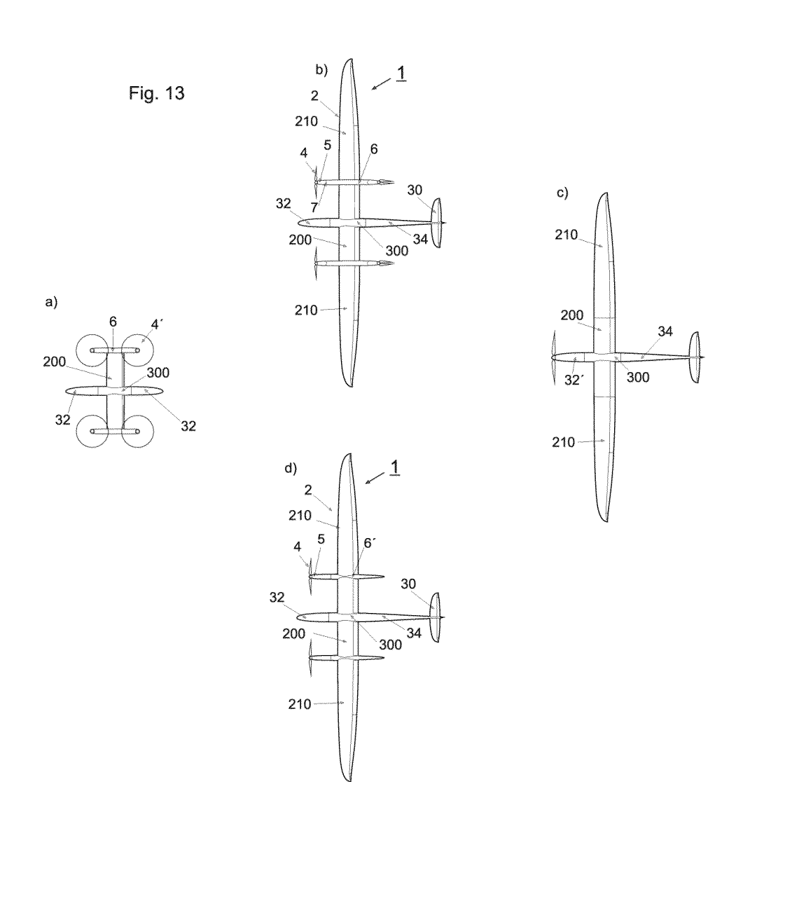

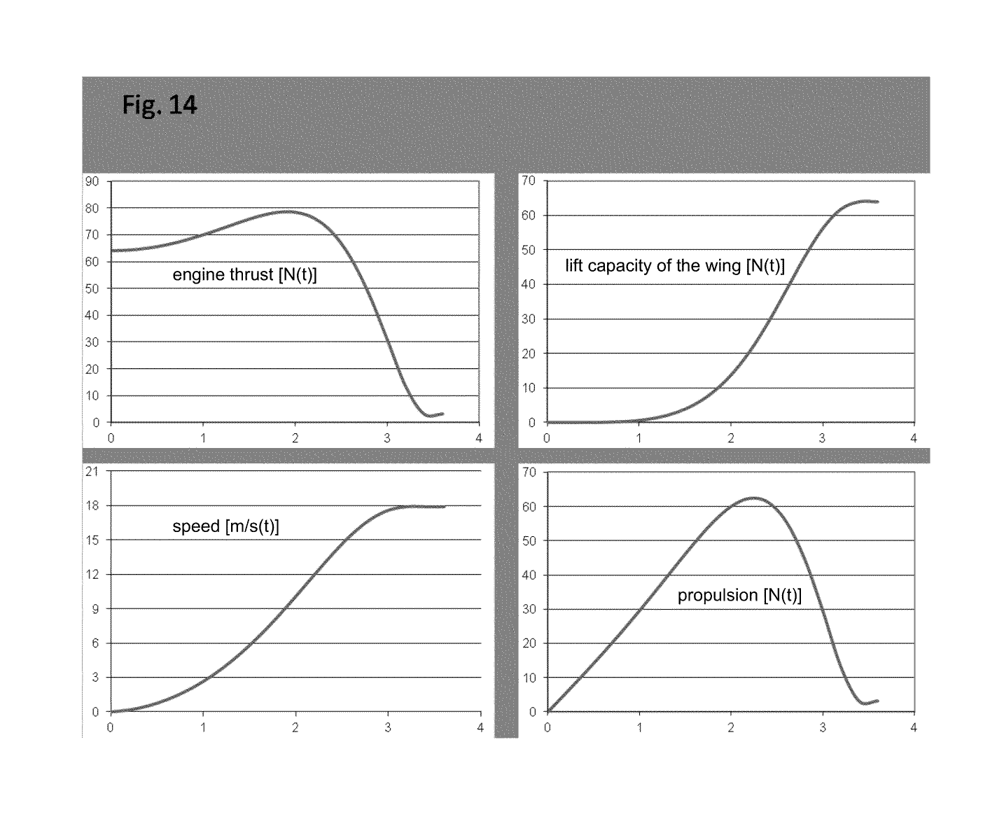

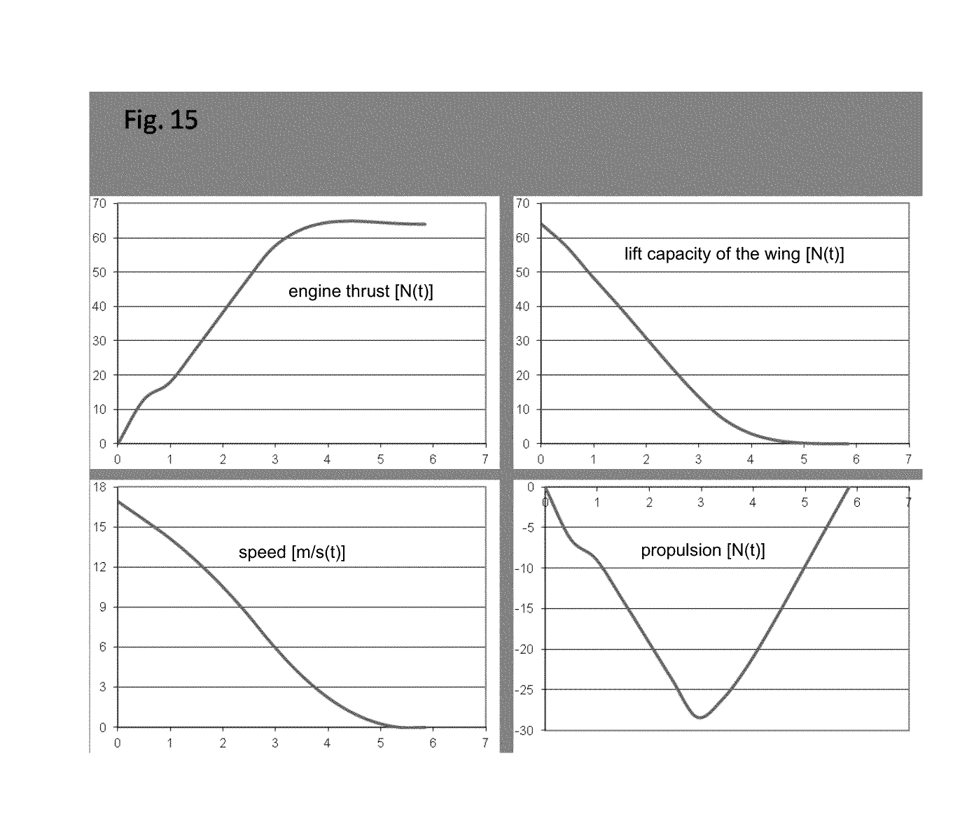

FIG. 13, showing a further preferred embodiment of the present invention, depicts the aerial vehicle 1 comprising a modular structure. The modular structure of the aerial vehicle 1 is designed in such way that for example—as shown in FIG. 13a—the central part of the aerial vehicle 1 can be used as an independent hovering platform 10. For this, merely the four rotors 4, 4′ and the respective electric motors 5 are provided, which are mounted on the central part of the wing 200 by means of two engine nacelles 6. The rear part of the fuselage 3 is dispensed with, instead fitting an additional nose 32 for further batteries and sensor systems.

The hovering platform 10 as shown in FIG. 13a corresponds in principle to the X-shaped central part of the aerial vehicle 1 illustrated in FIGS. 1 to 12. It is again schematically pictured in FIG. 13b, however with the previously mentioned modifications. Accordingly, both the drive—in form of the electric motors 5 and the rotors 4, 4′- and the entire control electronics and power supply of the aerial vehicle 1 can be used. The wing 2 is divided into at least three parts so that the outer wings 210 can be attached to the central part of the wing 200 in order to re-enable aerodynamic forward flight.

It is still possible to attach other components, such as the outer wings 210 and the rear 34, to the fuselage module 300 depicted in FIG. 13a, which also comprises the central part of the wing 200, in order to generate a conventional fixed wing aircraft which, however, then must be started and landed in a conventional manner.

The modular system of the aerial vehicle 1 preferably includes two different sets of outer wings 210, wherein a first set is optimized exclusively for cruise and a second set also has sufficient low speed flight characteristics, enabling conventional take-off and landing in slow flight.

The modular design comprising a central element—the fuselage module 300 and the central part of the wing 200, which in principle correlates with the floating platform depicted in FIG. 13a—and corresponding attachment modules makes it possible that by using the same technology, both a flexible floating platform and a highly efficient aerial vehicle can be provided. Thus, the characteristics of a floating platform are combined with a conventional fixed-wing aircraft, as is illustrated in FIG. 13b.

FIG. 13d shows a variant of the modular aerial vehicle, in which there are no motors and rotors attached to the rear of the engine nacelles 6′. Instead, a cowling/sleeve is fitted in order to improve aerodynamics. This variant of the aerial vehicle, which is illustrated in FIG. 13d, must also be launched and landed conventionally. However, by arranging the electric motors 5 and rotors 4 in the engine nacelles 6′, this variant allows an unobstructed line of vision from the fuselage module 300 or the nose 32. This can be of importance as regards the specific application of cameras or other sensors. By comparison the variant shown in FIG. 13c allows no such unobstructed view due to the rotors.

FIG. 14 shows how the transition from hover to forward flight takes place by means of schematic diagrams of the engine thrust, the bearing capacity of the wing and of the propulsion. At the beginning—at time 0—the front rotors 4 start pivoting forwards so that both the thrust of the rotors, providing the lift, and a forward component is generated. It follows from the speed diagram that at the same time the speed slowly increases. The engine thrust has to be raised in the short term by another 15% in order to maintain the altitude in hover and also to generate the appropriate forward motion, since the lift of the fixed wing 2 is not yet sufficient to take over and solely generate the lift.

As can be seen from the wing lifting capacity diagram, the lift of the wing only significantly rises when reaching a certain speed, after about 2 seconds. The wing profile of the fixed wing 2 is thus optimized so that there is sufficient lift only above a certain speed. Therefore, the wing profile is designed for higher speeds and as a result is very efficient as regards the range of the aerial vehicle 1.

The propulsion diagram shows that the aerial vehicle 1 accelerates most at around 2 seconds and that after that the acceleration gradually decreases.

FIG. 15 schematically illustrates the transition from aerodynamic forward flight to hover. For this, inter alia, the airbrakes are extended attaining a fast stop of the aerial vehicle. Simultaneously, the front rotors 4 are swiveled upwards from the level flight position—that is the forward position in which the thrust merely generates a forward movement—into the hover position or vertical take-off position. Further, the rear rotors 4′, which were switched off in the forward flight, are enabled to also generate lift. The rear rotors 4′ can also provide reverse thrust for braking. Accordingly, the aerial vehicle 1 decelerates quickly and the lift capacity of the wing 2 decreases correspondingly, so that in the end the rotors 4, 4′ solely generate the lift.

Insofar as applicable, all of the individual features that are presented in the various embodiments can be combined and/or exchanged without departing from the scope of the invention.

### REFERENCE SIGNS

1 Aerial vehicle
10 Hovering platform
2 Fixed wing
20 Wingtip
22 Connecting area of the wing
24 Aileron
26 Flaps
200 Central part of the wing
210 Outer wing
3 Fuselage
30 Tail unit
32 Nose
34 Rear part
300 Fuselage module
4 Front rotor
4′ Rear rotor
5 Electric motor
6 Nacelle
7 Pivot mechanism
S Span

1. An aerial vehicle comprising:
a fixed wing enabling aerodynamic level flight; and
at least four rotors driven by controllable electric motors, the at least four rotors pivotable between a vertical take-off position and a level flight position by means of a pivoting mechanism all of the electric motors and rotors are arranged on the wing.

2. The aerial vehicle according to claim 1, wherein the electric motors and the rotors are arranged in an X-shaped configuration with respect to the longitudinal axis of the aerial vehicle.

3. The aerial vehicle according to claim 1, wherein any of the at least four rotors in the vertical take-off position are pivotable in the same direction.

4. The aerial vehicle according to claim 1, further comprising a control device for operating the electric motors so that the aerial vehicle can automatically be retained in a stable hover.

5. The aerial vehicle according to claim 1, wherein a front rotor and a rear rotor with their respective electric motors are fitted to a wing by means of engine nacelles and via a pivot mechanism.

6. The aerial vehicle according to claim 1, wherein the rotors are arranged along a transverse extension of the wing, located between the wingtip and the connecting area of the wing to a fuselage of the aerial vehicle.

7. The aerial vehicle according to claim 1, wherein at least the rear rotors are designed as folding rotors.

8. The aerial vehicle according to claim 1, wherein a profile of the fixed wing generates a total lift for the aerial vehicle in aerodynamic forward flight at a speed of 50 km/h or higher.

9. The aerial vehicle according to claim 1, wherein the wing is solely optimized for cruise flight.

10. The aerial vehicle according to claim 1, wherein at least one of a battery, a fuel cell, or a photovoltaic solar cell is arranged in or on the aerial vehicle in order to supply energy to the electric motors.

11. The aerial vehicle according to claim 1, wherein the aerial vehicle includes a modular structure, the modular structure is configured for attachment of at least one of outer wings or a rear part thereto.

12. The aerial vehicle according to claim 11, wherein the modular structure comprises at least two sets of outer wings, wherein a first set of outer wings is exclusively optimized for cruise flight and a second set of outer wings is also suitable for slow flight.

13. The aerial vehicle according to claim 1, wherein the aerial vehicle further comprises at least one of an Unmanned Aerial Vehicle (UAV), a drone, or an Unmanned Aerial System (UAS).

14. The aerial vehicle according to claim 3, wherein any of the at least four rotors can be pivoted upwards.

15. The aerial vehicle according to claim 6, wherein the rotors are arranged at an inner third of the transverse extension of the wing between the connecting area and the wingtip.

16. The aerial vehicle according to claim 8, wherein a profile of the fixed wing generates the total lift for the aerial vehicle in aerodynamic forward flight at speeds between 70 km/h and 300 km/h.

17. The aerial vehicle according to claim 8, wherein a profile of the fixed wing generates the total lift for the aerial vehicle in aerodynamic forward flight at speeds between 90 km/h and 180 km/h.

18. The aerial vehicle according to claim 11, wherein the modular structure comprises a hovering platform, the hovering platform comprising rotors and electric motors.
